(19) United States
(12) Patent Application Publication
(10) Pub. No.: US 2025/0109829 A1
(43) Pub. Date: Apr. 3, 2025

(54) OUTLET BOSS FOR A PRESSURIZED-FLUID STORAGE TANK, AND TANK COMPRISING SUCH A BOSS

(71) Applicants: AD-VENTA, CHATEAUNEUF SUR ISERE (FR); RAIGI, ROUVRAY-SAINT-DENIS (FR)

(72) Inventors: Jean-Luc MUSSOT, VALENCE (FR); Olivier PERRIER, NEUVILLE-AUX-BOIS (FR)

(21) Appl. No.: 18/979,595

(22) Filed: Dec. 13, 2024

Related U.S. Application Data
(63) Continuation-in-part of application No. PCT/FR2023/050853, filed on Jun. 13, 2023.

(30) Foreign Application Priority Data
Jun. 14, 2022 (FR) 2205725

(51) Int. Cl. F17C 13/12

(52) U.S. Cl. CPC F17C 13/12; F17C 2203/0604; F17C 2203/0636; F17C 2205/0305

(57) ABSTRACT

The invention relates to an outlet boss for a pressurized-fluid storage tank, comprising an axial central part able to pass through the envelope of the tank and itself having passing through it at least one channel communicating by its proximal end with the inner chamber of the storage tank, and the distal end of which is closed along its axis of same direction XX′ as the boss, a radial internal part able to secure the boss to the envelope of the tank, and an axial external part comprising at least one radial outlet duct for the fluid that communicates with the channel and opens, by its other opposite end, to the outside of the boss and is able to receive therein any fluid outlet connection element, the boss forming in one piece an integrated dispensing head.

### CROSS-REFERENCE TO RELATED APPLICATIONS

The present application claims priority to and is a continuation-in-part of International Application No. PCT/FR2023/050853, filed Jun. 13, 2023, which claims priority to French Application No. 2205725 filed with the French National Institute of Industrial Property (INPI) on Jun. 14, 2022, both of which are incorporated herein by reference in their entirety for all purposes.

### TECHNICAL FIELD OF THE INVENTION

The present invention relates to an outlet boss for a pressurized-fluid storage tank and tanks comprising such a boss.

The technical field of the invention is that of the manufacture of fluid storage tanks, such as bottles made of composites, under pressure and even high pressure such as at least 250 bar for CNG (Natural Gas Vehicles) or at least 350 bar or even 700 bar for hydrogen, the envelope of such tanks generally being made by winding or coiling composite fibers around a metal or thermoplastic liner, and comprising at least one outlet and/or inlet orifice communicating with the fluid storage chamber delimited by the tank envelope.

### TECHNICAL BACKGROUND

Various types of tanks equipped with such orifices are known: for example, patent application EP1234654 by Essef Corporation, published on Feb. 28, 2002, teaches a method for manufacturing reinforced thermoplastic composite hollow items, such as a pressurized container, and comprising an axial opening produced by inserting, in the envelope of the said hollow items, the neck of a fastening part comprising a threaded channel and passing right through this part, so that, on the one hand, a collar portion of this part presses against the inner surface of the envelope of the hollow item in question and, on the other hand, a threaded core is screwed into the end of the threaded channel opening to the outside of this hollow item, this core being pierced by various ducts allowing communication with the storage chamber delimited by the said envelope.

Another example is patent application EP1151224 by Alliant Ammunition Systems, published on Nov. 7, 2001, which teaches a pressurized gas tank comprising:
a storage chamber with an access opening,
a polar boss or hub passing through this opening, fixed and integral with it, and comprising a threaded channel passing right through this boss or hub, and opening to the outside of the storage chamber,
a plastic lining that lines the interior of the envelope which delimits the storage chamber, securing the end flange of the boss against the interior of the envelope and comprising a sleeve portion extending into part of the interior of the boss, and
a base or fitting body, screwed both into the outer end of the boss and into the inner sleeve of the plastic liner until it seals against the end of this sleeve, which base is pierced by a duct enabling communication with the storage chamber.

Thus, in all the above devices and many others, pressurized-fluid storage tanks always feature at least one boss, neck or hub (hereinafter referred to as “boss”) with a threaded internal bore, fitted during tank manufacture and integral with the tank envelope; the internal diameter of this bore must be large enough to allow a base, core or fitting body to be screwed axially into it (depending on patent applications and/or technical data sheets, this part is referred to here as a “base”).

This base is usually fitted with a head to which valves and fittings can be attached, and is pierced by one or more ducts communicating with the storage chamber: this means that the internal pressure of the tank, which can be at least 250 bar for CNG and even 700 bar or more for hydrogen, places considerable stress on the boss, the base and the thread that connects them, making it all the more necessary to use thicker parts to withstand it, and making assembly all the more critical.

Moreover, in the event of accidental pulling off of the tank head screwed to the base, creating a fairly large-diameter opening communicating with the tank's storage chamber, leakage of the pressurized fluid stored there would be significant and could generate even greater risks.

In order to reduce the dimensions of the boss and the base and to simplify these parts, thereby reducing tank manufacturing costs, especially for high-pressure tanks such as those at 700 bar, and also to reduce the risks associated with leaks, a tank outlet boss has been developed which integrates the base and thus forms a single part with it, as described in patent application WO2020/225262 filed by Faurecia Exhaust Systems and published on Nov. 12, 2020; and which describes a boss comprising:
an axial central part able to pass through the envelope of the said tank and is itself traversed by at least one axial channel able to communicate by its proximal end with the inner chamber of the fluid storage tank and whose distal end is closed,
an internal radial part capable of securing said boss to the envelope of the tank and of holding the fluid pressure forces on said boss, and
an axial external part comprising at least one radial fluid outlet duct communicating with the axial channel towards its distal end,

and the said boss thus acting as a base is able to receive directly, around its axial external part without any other intermediate part, a fluid dispensing head (called valve with a substantially annular shape in this Faurecia patent application where the word dispensing head designates the whole assembly of the boss and the valve) comprising at least one radial duct opening, through one of its ends, outside the head to receive there any fluid outlet connecting element and communicating, through its opposite end, with the axial duct of this axial external part.

### SUMMARY OF THE INVENTION

Such an arrangement does, of course, partly overcome the disadvantages cited above in previously known devices, but it also presents a safety problem in the system for attaching the tank head (or valve) to such a boss integrating the base, and in the connection of fluid outlet connector elements to the head (or valve): the use of pressurized fluid tanks or bottles entails risks due to the pressure itself, as well as to the type of fluid (which may be flammable, harmful, etc.).

Head-mounted components must therefore be correctly dimensioned (with safety coefficients, etc.) to withstand pressure, but the assembly of these various components can lead to risks of leakage due to assembly (incorrect sealing) or use (unscrewing due to vibration, etc.).

The aim of the present invention is not only to further simplify parts and reduce tank manufacturing costs, but also to ensure greater security in the attaching and sealing of the various components, including the fluid outlet connecting elements connected to it, while providing the possibility of working on these elements in the event of a problem.

Such an objective is achieved with an outlet boss for a pressurized-fluid storage tank having central, radial and axial portions, as described in the above-mentioned document WO2020/225262,
the axial central part being able to pass through the envelope of the said tank and itself having passing through it at least one channel communicating by its proximal end with the inner chamber of the fluid storage tank and the distal end of which is closed along its axis in the same direction as the boss,
the radial internal part being able to secure the said boss to the envelope of the tank and hold the pressure forces of the fluid on this boss,
the so-called axial external part comprising at least one radial outlet duct for the fluid that communicates with the channel which itself communicates with the inner chamber towards its distal end,
   and according to the invention
the boss forming in one single piece an integrated dispensing head in its axial external part, without an intermediate piece as the valve of the prior art Faurecia patent application with a substantially annular shape.
the end of the at least one radial duct opens, through one of its ends, outside the boss
which at least one radial duct, communicating through its opposite end with the channel, is able to receive, at its end, any fluid outlet connecting element
the axial channel of said boss constitutes a simple communication duct.
   The objective of the invention is further achieved by an externally operated safety system which closes the distal end of the axial channel and is capable of closing the radial ducts opening out of the boss and communicating, when the safety system is open, with the axial channel; this makes it possible to work on the fluid outlet connector elements connected to the radial ducts in the event of a problem, such as a leak, since closing the safety system isolates these elements, which can then be removed despite the pressure of the fluid contained in the tank.

The objective of the present invention is also achieved by a pressurized-fluid storage tank comprising, at least from its manufacture, an outlet boss for this fluid as above, integrating both the base and the fluid dispensing head and forming a single part with them without any other connecting, attachment or sealing parts.

In a particular embodiment, the axial central part of the boss, which passes through the envelope of the said tank, comprises a cylindrical part forming a protrusion beyond the radial part, known as the internal part, of the boss, and therefore inside the tank, making it possible to fit any sensor placed there through a second channel passing through the axial central part of the boss.

This new type of pressurized-fluid storage tank outlet boss, and these new pressurized-fluid storage tanks, meet the set objective, provide numerous advantages and prove their worth, such as:
compared with boss/base and head assemblies, which have an intermediate substantially annular shape valve, which are threaded and attached around the axial external part of the boss/base essentially by a nut screwed onto it and locking the head (or valve) against a shoulder, and which then present safety and sealing risks, a single part, ensuring, according to the present invention, all the functions of base and tank head, eliminates such risks
the absence of other attachments or sealing components simplifies tank manufacture,
there is no longer any risk of the tank head being pulled off,
to date, if a leak is detected in certain situations, at the level of the connection of the fluid outlet connecting elements on the tank head (in the present invention, on the boss itself), as it is not possible to work on this bottle head because of the danger that could be caused by this leak, the repair can only be carried out when the bottle or tank is completely emptied: according to the present invention, the so-called safety closure system makes it possible to isolate all the boss outlets from the inflow of pressurized fluid, thus ensuring the safety of the bottle's environment in the event of such a leak.
when the envelope of the tank is produced by rotational molding reinforced by winding composite carbon fibers, these fibers are wound and supported around the radial internal part, forming a groove between the radial inner and axial outer parts, and this makes it possible, especially when the boss integrates and forms a single part with the head, to absorb and transmit the energy from the boss to the composite fibers when the tank is subjected to an axial impact on the outer face of the boss: the force due to this impact is thus transmitted all the better by the boss according to the invention to the fibers making up the envelope.

### BRIEF DESCRIPTION OF THE FIGURES

Further features and advantages of the invention will become apparent in the course of the detailed description which follows, for the understanding of which reference is made to the appended figures which show various examples of the embodiment of a boss and a tank (or bottle) according to the invention, but other modes of embodiment are possible within the scope of the present invention:

FIG. 1 is an external profile view of a pressurized-fluid storage tank according to the invention and equipped with a boss according to the invention as shown in FIGS. 2 to 9.

FIG. 2 is a partial longitudinal sectional view, along III, III′ of FIG. 1, of the upper part of the tank fitted with a boss according to the invention.

FIG. 3 is a partial cross-sectional view like that of FIG. 2 but concerning a particular embodiment of a boss according to the invention, thus incorporating the tank head of the prior art, with a first type of safety closure system, in the open position, of the axial channel able to communicate via its proximal end with the inner chamber of the fluid storage tank.

FIG. 4 is the same partial cross-section as FIG. 3, but with the axial channel safety closure in the closed position.

FIG. 5 is a partial cross-sectional view, like that of FIG. 3, concerning another particular embodiment of a boss according to the invention with a second type of safety closure system, in the closed position, of the axial channel, and combined with an axial outlet or inlet equipped with a so-called self-closing system, also in the closed position.

FIG. 6 is the same partial cross-section view as FIG. 5, with the second type of axial channel safety closure system in the open position, and the so-called self-closing system still in the closed position.

FIG. 7 is the same partial cross-section as FIGS. 5 and 6, with the second type of axial channel safety closure system in the open position, and the so-called self-closing system also in the open position.

FIG. 8 is a partial cross-sectional view, like that of FIG. 3, of another particular embodiment of a boss according to the invention without a safety closure system for the axial channel, but with an axial outlet or inlet equipped with a so-called self-closing system, in the closed position.

FIG. 9 is the same partial cross-section as FIG. 8, but with the self-closing system in the open position.

In the following description, identical, similar or analogous elements will be referred to by the same reference numbers.

### DETAILED DESCRIPTION OF THE INVENTION

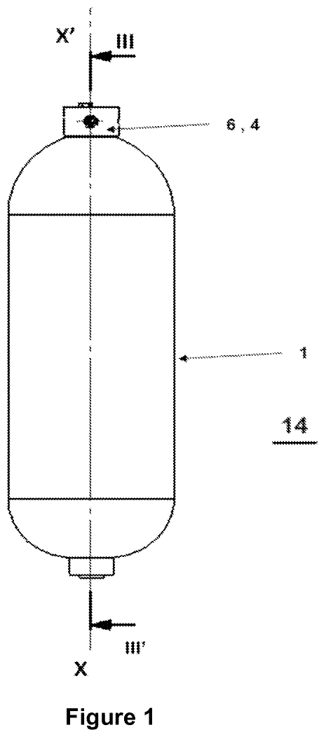

In a known manner as taught in the aforementioned patent application WO2020/225262, the said tank 1 comprises an envelope 2 which defines the inner chamber 5 for storing the fluid under high pressure and which is able to hold this high pressure such as at least 250 bars and even 350 or 700 bars, and at least one boss 4, of generally cylindrical shape, at the outlet of the tank 1 for storing fluid under high pressure, comprising:
an axial central part 4₃, cylindrical in shape with the same axis XX′ as that of the tank as shown in FIG. 1, the central part whereof can be described as internal and which, passing through the envelope 2 of the said tank 1, is itself traversed by at least one axial channel 8 with the same direction as the axis XX′, communicating by its proximal end 8₁ with the inner chamber 5 of the fluid storage tank to enable the latter to exit, and whose distal end 8₂ of the channel 8 is closed along its axis with the same direction XX′ as the boss 4,
a radial part 4₁, referred to as the internal part, securing said boss 4 to the envelope 2 of the tank 1 and capable of holding the forces due to the internal pressure of the tank on this boss 4.
an axial external part 4₂ comprising at least one radial fluid outlet duct 9 for the fluid that communicates with the channel 8₂.

And in accordance with the invention, said boss 4 not only acts as a base but also forms an integrated fluid dispensing head in a single piece, without any other intermediate parts, as the valve of the patent application WO2020/225262, and
the end 12₁ of the at least one radial duct 9 opens, with one of its ends, on the outside 14 of the boss 4
which at least one radial duct 9 communicating, by its opposite end, with channel 8, is able to receive, at its end 12₁, any fluid outlet connector element 10
and the channel 8 of said boss 4 constitutes a simple communication duct,

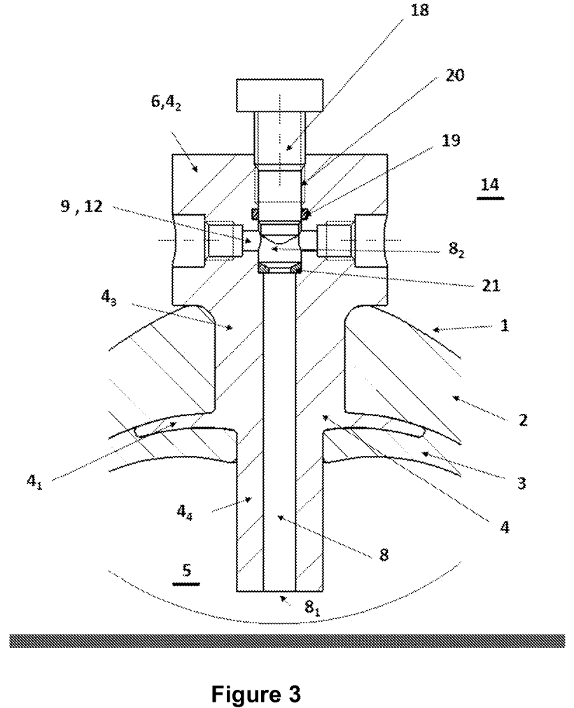

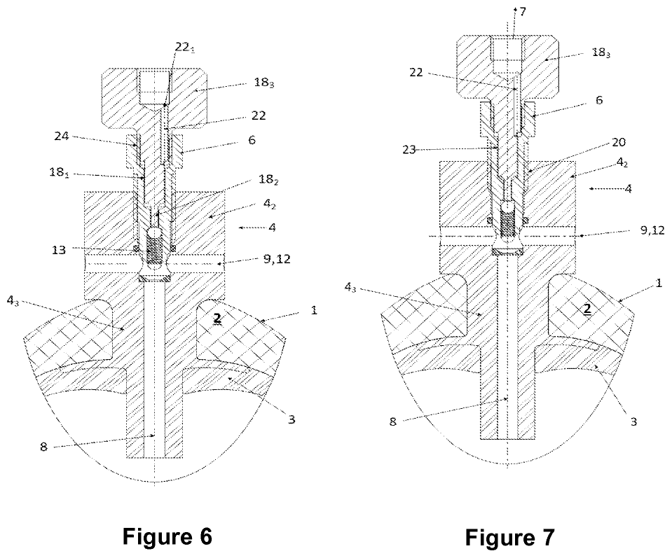

The distal end 8₂ of channel 8 can be closed during machining of boss 4, either by not drilling all the way through channel 8 from its proximal end 8₁, or by drilling until it emerges on the outside of boss 4, then closing this hole in a leaktight manner, such as, after threading and other possible and/or necessary machining, by screwing in a sealing plug 18, which may even constitute a safety system as described below and shown in FIGS. 3 to 7.

According to the exemplary embodiments shown in the figures, the so-called axial external part 4₂ of boss 4, located on the outside 14 of the envelope 2 of tank 1, has at least two ducts 9 arranged radially with respect to axis XX′ and distributed, evenly or unevenly, around the periphery of this axial external part 4₂,

According to the present invention and to the exemplary embodiments shown in FIGS. 3 to 9, the distal end 8₂ is closed by a safety system 18 operated from the outside 14 and capable of closing the radial ducts 9, 12: this may be, as shown, a plug 18 which is screwed 20 into the axis of the channel 8 through the upper face of the axial part 4₂ of the boss 4.

In FIG. 3, the plug 18 is shown unscrewed in the open position, thus freeing the distal end 8₂ of the channel 8, which thus communicates with the radial channels 9, 12 and allows the fluid stored in the chamber 5 of the storage tank to pass freely to the outside 14, and therefore to any fluid outlet connector elements 10 connected to these radial channels 9, 12 (see below), a seal 19, which may be toroidal or of another shape, ensuring the sealing of this plug 18 with respect to the boss 4.

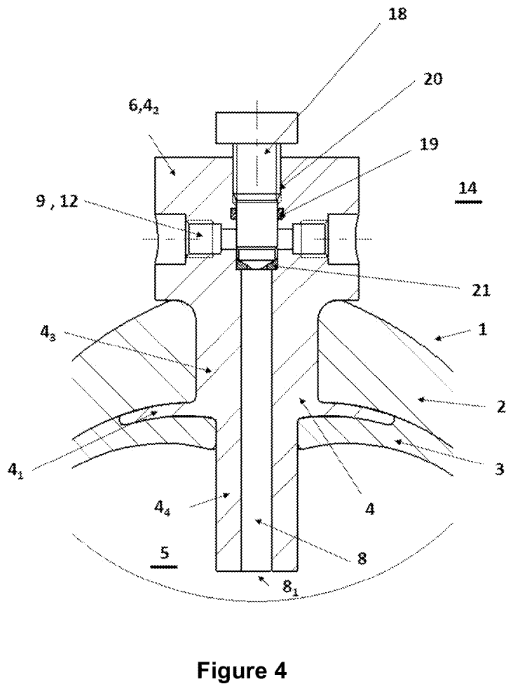

In FIG. 4, the plug 18 is shown screwed down (operation can be performed from the outside 14) in the closed position, thus closing off the distal end 8₂ of the channel 8 and preventing the passage of fluid to the radial channels 9, 12 and therefore to any fluid outlet connector element 10 connected to it: if one of these elements 10 fails, such as a leak or the like, it is then possible to intervene without waiting for the tank to be empty, and a seal 21, shown here against a shoulder located at the end of plug 18 and crushed by it when this plug is closed, ensures the seal between this plug 18 and channel 8.

This safety system 18 can be operated mechanically (by manual closure as shown in the figures, for example by turning the head 18₃ of the plug 18 forming its proximal end, using a key) or controlled by an automatic system (electrical, hydraulic, etc.).

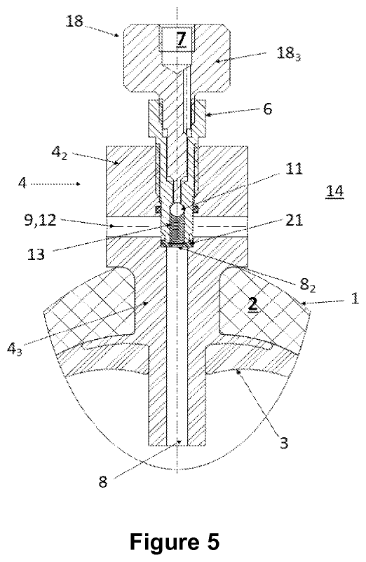

In FIGS. 5 to 7, the plug 18 has a fluid outlet or inlet 7, which can be axial and which, for example, enables the tank 1 to be connected to other fluid storage sources and, in particular, to be filled or emptied: for this purpose, as the distal end 8₂ of the channel 8 of the boss 4 can be closed by the plug 18, operated from the outside 14 (as in the other exemplary embodiment shown in FIG. 4), the latter comprises a channel 22 opening out at its distal end 22₁ into the outlet/inlet 7 and at its other opposite proximal end into a duct 23 (which may be a bore surrounding the stem 18₁ of the plug 18) communicating with the distal end 18₂ of the plug.

This distal end 18₂ of the plug is inserted into a bore of a sealing valve 6 which comprises a sealing ball 11 held closed against the opening of the duct 23 by a spring 13 and which can be opened by maneuvering the head 18₃ of the plug 18, the distal end 18₂ of the latter then pushing the ball 11 which thus compresses the spring 13 and opens the passage allowing the fluid either to escape or to re-enter the tank 1 via the channel 8: such a system is said to be self-closing, capable of opening communication between channel 8 and channel 22, and thus to the outside 14, by displacement of plug 18, which acts here as a connector sealing valve 6, which provides the manual safety closing function.

According to FIGS. 5 to 7, the sealing valve 6 is intermediate between the plug 18, which is then screwed 24 into this valve 6, and the axial part 4₂ of the boss 4 into which the valve 6 is screwed: the latter, when completely closed, as in FIG. 5, by screwing 20 into the axial part 4₂, crushes the gasket 21 and, as in the other embodiment of FIG. 4, ensures a seal between the plug 18 and the channel 8; no fluid can then pass through to the radial channels 9, 12 and therefore to any fluid outlet connector element 10 connected to them.

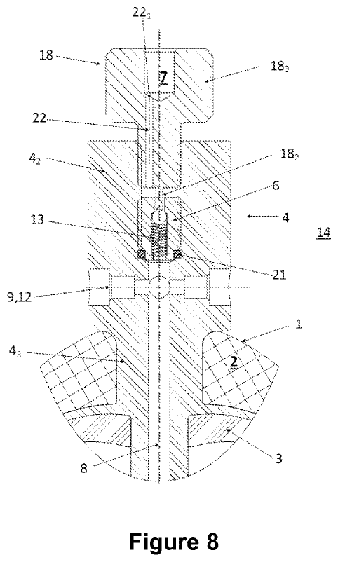

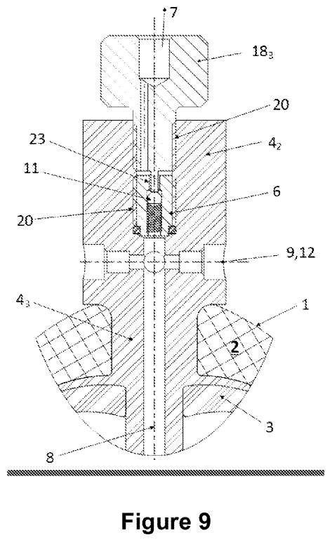

On the other hand, according to FIGS. 8 and 9, the sealing valve 6 is also screwed into the axial part 4₂ of the boss 4, but in a fixed manner and perhaps in the same thread 20 as that of the plug 18:
in this embodiment, there is a fluid outlet or inlet 7, but no safety system able to close off the at least one radial duct 9.

Thus, either the boss 4 comprises only a safety system 18 capable of closing the channel 8 and sealing the radial ducts 9, 12, or a self-sealing system capable of opening/closing the communication between the channel 8 and a fluid outlet/inlet channel 22, or a combination of the safety system 18 comprising a self-sealing system.

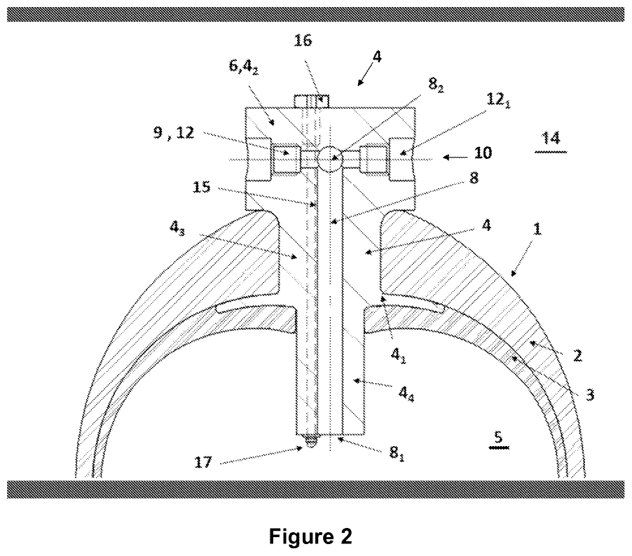

In the preferred exemplary embodiment shown in FIG. 2, the axial central part 4₃, which passes through the envelope 2 of the said tank 1 and is itself traversed by at least one channel 8, comprises a cylindrical part 4₄ forming a protrusion inside the tank 1 beyond the radial part 4₁ referred to as internal.

This axial central part 4₃, especially if it includes such a protrusion 4₄, includes at least one second channel 15 which passes axially through this central part 4₃ and which is suitable for receiving any measurement sensor such as a temperature sensor, which is very useful for monitoring the operation of the tank 1 in operation and is even necessary during its manufacture when it is made by rotational molding such as by winding composite carbon fibers; and as it is not the same in these two applications, it is necessary to be able to remove and replace it by sliding it into this second channel 15 from the outside 14, bearing in mind that the end of this second channel opening to the outside is sealed by a gland or plug 16 to hold the pressure inside the tank 1, and its other end opening into the tank 1 can itself be protected from the fluid inside the tank 1 by a device of the immersion sleeve type 17:
the sensor for monitoring the temperature during manufacture of tank 1 by rotational molding has a temperature range of 20 to 260° C.
while the sensor for monitoring the inside of tank 1 during operation has a different temperature range (such as −60° C./+150° C.).

This cylindrical part 4₄, forming a protrusion inside the tank 1, provides a better temperature measurement.

As shown in FIG. 2 and already indicated above in relation to the tank head of the prior art, the axial part 4₂ of the boss 4, referred to as the external part, comprises at least two ducts 9, 12 arranged radially in relation to the axis XX′ and distributed around the periphery of this axial external part 4₂ of the boss: these radial ducts 9, 12, opening to the outside 14 of boss 4 and communicating by their end inside boss 4 with channel 8 closed at its distal end 8₂, are each able to receive at their opposite end 12₁ opening to the outside 14, any fluid outlet connector element 10, such as a valve connecting boss 4, thus also forming a tank head, to any pressurized fluid supply pipe or hose, or a component ensuring a safety function, or even a plug.

The tank 1 for storing pressurized fluids according to the invention, as shown in the attached figures, comprises at least one boss 4 for the outlet of this fluid, as described above, integrating both the functions of base and tank head in a single piece according to the characteristics explained above: in addition to the advantages already indicated above, such as very good resistance to mechanical stress, such a boss 4 also provides axial strength along XX′ of the envelope during manufacture, with good axial positioning.

The radial part 4₁ can be bonded or molded to the envelope 2 of the tank 1, in order to hold the forces due to the internal pressure of the tank on the boss 4, or, as shown in FIGS. 2 to 4, between the envelope 2 and an internal lining 3, such as a thermoplastic or metal liner, covering the entire inner part of the envelope 2 of the tank 1 and covering this radial part 4₁.

In a particular embodiment, when the tank 1 has a metallic inner liner 3 covering the whole of the inner part of the tank 1 envelope 2, the radial internal part 4₁ of the boss 4 may be part of this inner liner 3 or liner, the boss 4 then being an integral part of this liner.

We are reminded that the pressurized fluid in tank 1 can be CNG (Natural Gas for Vehicles) at at least 250 bar, as well as hydrogen at at least 350 bar, but also at pressures greater than or equal to 700 bar.

1. An outlet boss for a pressurized-fluid storage tank comprising:
an axial central part along an axis XX′ passing through the envelope of said tank and itself having passing through it at least one channel communicating by its proximal end with the inner chamber of the fluid storage tank and the distal end of which is closed along its axis of the same direction XX′ as the boss,
a radial internal part securing said boss to the envelope of the tank and able to withstand the pressure forces of the fluid on this boss, and
an axial external part comprising at least one radial fluid outlet duct for the fluid that communicates with the channel towards its distal end,
wherein:
said boss forms in once piece an integrated dispensing head,
the end of the at least one radial duct opens, with one of its ends, on the outside of the boss
which at least one radial duct communicating, by its opposite end, with channel, is able to receive, at its end, any fluid outlet connector element
and the channel of said boss constitutes a simple communication duct.

2. The boss for the outlet of a pressurized-fluid storage tank according to claim 1, wherein the distal end of the channel of said boss is closed by a safety system operated from the outside and which is able to seal the at least one radial conduit.

3. The boss for the outlet of a pressurized-fluid storage tank according to claim 1, wherein the distal end of the channel of said boss is closed by a plug operated from the outside and which comprises a channel opening by its distal end into an axial fluid outlet/inlet and by its other opposite proximal end into a duct communicating with the distal end of the plug which is inserted into a self-sealing system capable of opening the communication between the channel and the channel by displacement of the plug.

4. The boss for the outlet of a pressurized-fluid storage tank according to claim 2, wherein that the safety system comprises a self-sealing system as capable of opening the communication between the channel and the channel by displacement of a plug, wherein the distal end of the channel of said boss is closed by the plug operated from the outside and which comprises a channel opening by its distal end into an axial fluid outlet/inlet and by its other opposite proximal end into a duct communicating with the distal end of the plug which is inserted into a self-sealing system.

5. The boss for the outlet of a pressurized-fluid storage tank according to claim 1, wherein its axial central part, passing through the envelope of said tank and itself having passing through it at least one channel, comprises a cylindrical part forming a protrusion beyond the radial part referred to as the internal part of the boss.

6. The boss for the outlet of a pressurized-fluid storage tank according to claim 1, wherein the axial central part comprises at least one second channel which passes axially through this central part and which is suitable for receiving any measurement sensor.

7. The boss for the outlet of a pressurized-fluid storage tank according to claim 1, wherein the so-called axial external part thereof comprises at least two ducts arranged radially with respect to the axis XX′ and distributed over the periphery of this axial external part.

8. A storage tank for pressurized fluid comprising at least one outlet boss for this fluid, wherein this outlet boss is according to claim 1.

9. The pressurized-fluid storage tank according to claim 8 and comprising a metallic inner lining covering the whole of the inner part of the envelope of the tank, wherein the radial internal part of the boss is part of this inner lining, the boss being an integral part of this lining.
